(19) United States
(12) Patent Application Publication
(10) Pub. No.: US 2022/0099698 A1
(43) Pub. Date: Mar. 31, 2022

(54) INERTIAL MEASUREMENT UNIT

(71) Applicant: SEIKO EPSON CORPORATION, Tokyo (JP)

(72) Inventors: Masayasu Sakuma, Shiojiri-shi (JP); Shinji Nishio, Suwa-shi (JP)

(21) Appl. No.: 17/481,768

(22) Filed: Sep. 22, 2021

(30) Foreign Application Priority Data
Sep. 25, 2020 (JP) 2020-161007

(51) Int. Cl. G01P 15/125; G01P 15/18; G01P 3/02; G01K 13/00

(52) U.S. Cl. CPC G01P 15/125; G01K 13/00; G01P 3/02; G01P 15/18

(57) ABSTRACT

An inertial measurement unit includes: a substrate including a first surface and a second surface orthogonal to a Z-axis and having a front-back relationship with each other; an inertial sensor installed at the first surface of the substrate; a semiconductor device installed at the second surface of the substrate and electrically coupled to the inertial sensor; and a plurality of lead terminals coupled to the substrate and configured to support the substrate to a mounting target surface. The plurality of lead terminals have a first part coupled to the substrate, a second part mounted at the mounting target surface, and a third part located between the first part and the second part and extending in a direction having a component along the Z-axis. The semiconductor device is exposed from between the plurality of lead terminals, as viewed in a plan view from a direction orthogonal to the Z-axis.

The present application is based on, and claims priority from JP Application Serial Number 2020-161007, filed Sep. 25, 2020, the disclosure of which is hereby incorporated by reference herein in its entirety.

### BACKGROUND

### 1. Technical Field

The present disclosure relates to an inertial measurement unit.

### 2. Related Art

An electronic device described in JP-A-2009-164564 includes: an electronic component such as a vibrator installed at a top surface of a ceramic substrate; an electronic component such as a control element installed at a bottom surface of the ceramic substrate; a plurality of lead terminals; a bonding wire electrically coupling the ceramic substrate and the plurality of lead terminals; and a mold part for molding each electronic component and fixing the plurality of lead terminals to the ceramic substrate.

When the electronic component in the above configuration is a microcomputer, the electronic component is a heat source. However, the electronic component is molded and therefore poses a problem in that the heat generated by the electronic component does not easily dissipate and is trapped inside the device.

### SUMMARY

An inertial measurement unit according to an aspect of the present disclosure includes: where an X-axis, a Y-axis, and a Z-axis are provided as three axes orthogonal to each other, a substrate including a first surface and a second surface orthogonal to the Z-axis and having a front-back relationship with each other; an inertial sensor installed at the first surface of the substrate; a semiconductor device installed at the second surface of the substrate and electrically coupled to the inertial sensor; and a plurality of lead terminals coupled to the substrate and configured to support the substrate to amounting target surface. The plurality of lead terminals have a first part coupled to the substrate, a second part mounted at the mounting target surface, and a third part located between the first part and the second part and extending in a direction having a component along the Z-axis. The semiconductor device is exposed from between the plurality of lead terminals, as viewed in a plan view from a direction orthogonal to the Z-axis.

### BRIEF DESCRIPTION OF THE DRAWINGS

FIG. 1 is a lateral cross-sectional view showing an inertial measurement unit according to a preferred embodiment.

FIG. 2 is a cross-sectional view taken along a line A-A in FIG. 1.

FIG. 3 is a cross-sectional view of an angular velocity sensor.

FIG. 4 is a cross-sectional view of an acceleration sensor.

FIG. 5 is a side view of the inertial measurement unit.

FIG. 6 is a cross-sectional view showing the relationship between the widths of a lead terminal and an external coupling terminal.

FIG. 7 shows the relationship between the height of a substrate and a stress.

FIG. 8 is a plan view showing lead terminals.

### DESCRIPTION OF EXEMPLARY EMBODIMENTS

An electronic device according to an aspect of the present disclosure will now be described in detail, based on an embodiment illustrated in the accompanying drawings. For the sake of convenience of the description, three axes orthogonal to each other, that is, an X-axis, a Y-axis, and a Z-axis, are shown in each illustration. A direction along the X-axis is referred to as “X-axis direction”. A direction along the Y-axis is referred to as “Y-axis direction”. A direction along the Z-axis is referred to as “Z-axis direction”. An arrow side along the Z-axis direction is referred to as “top”. The opposite side is referred to as “bottom”.

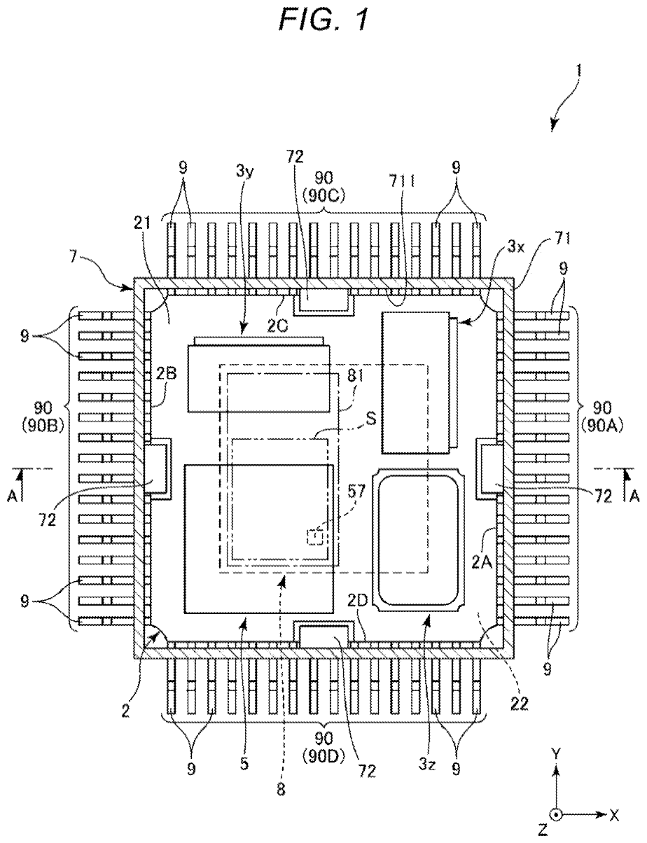

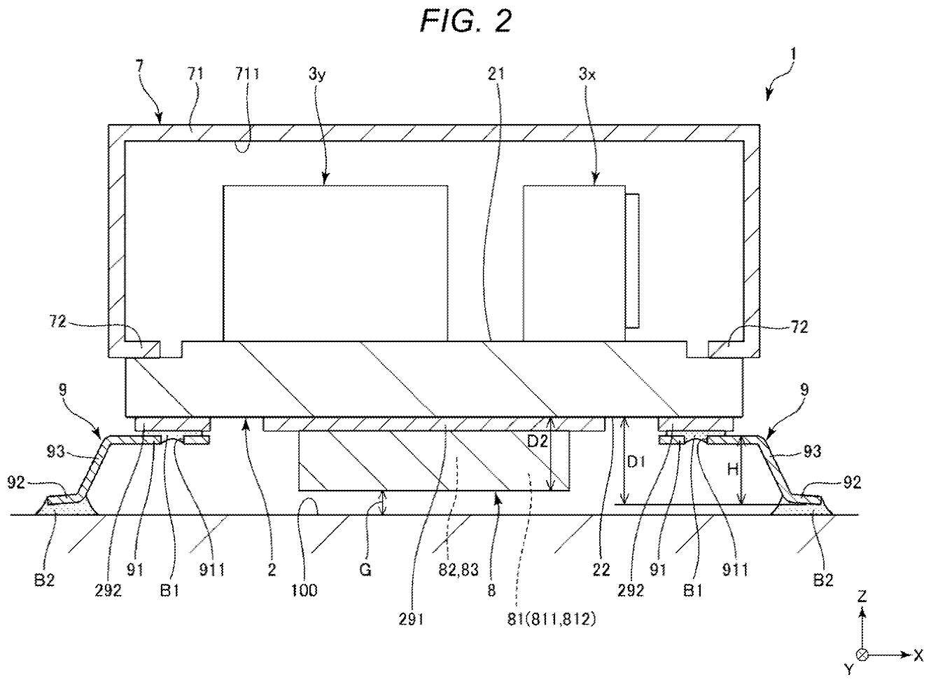

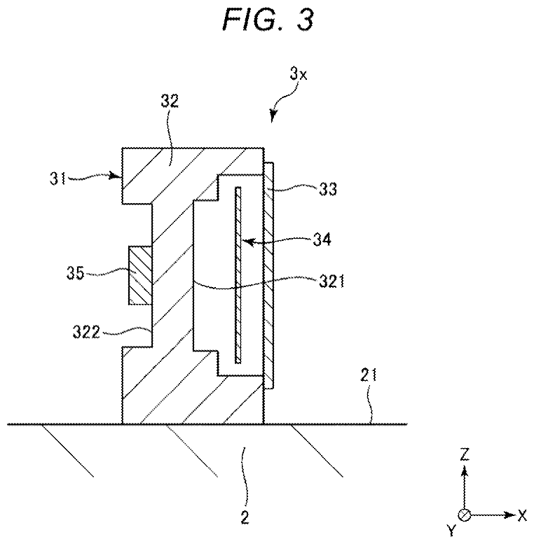

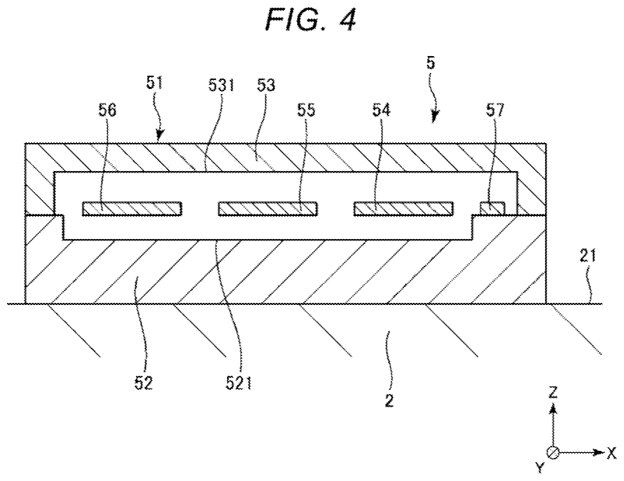

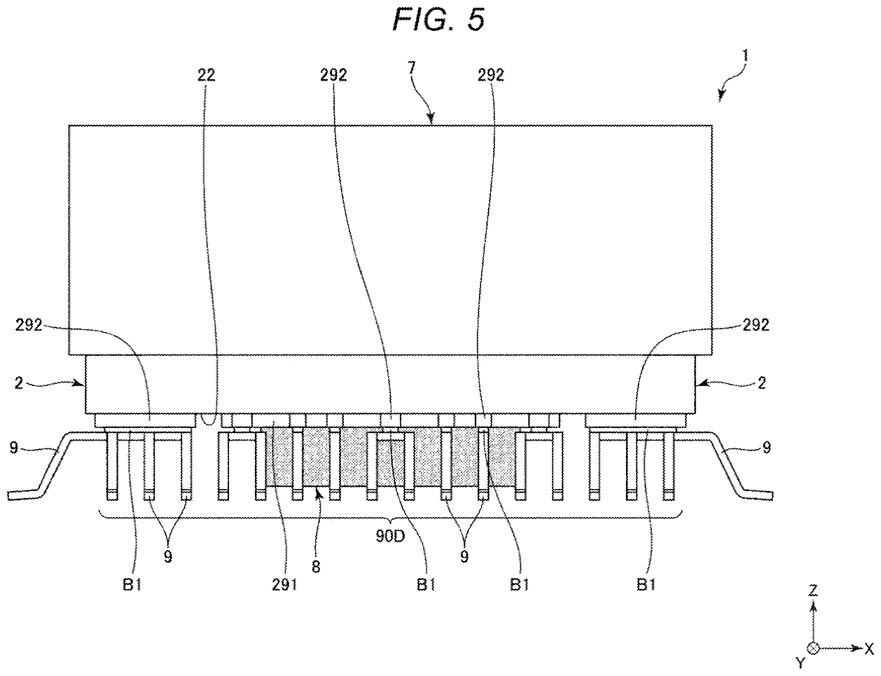

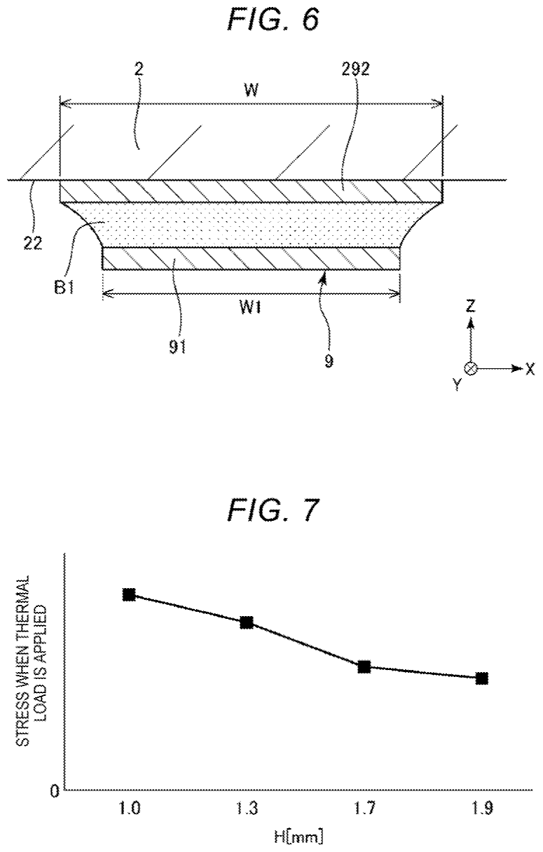

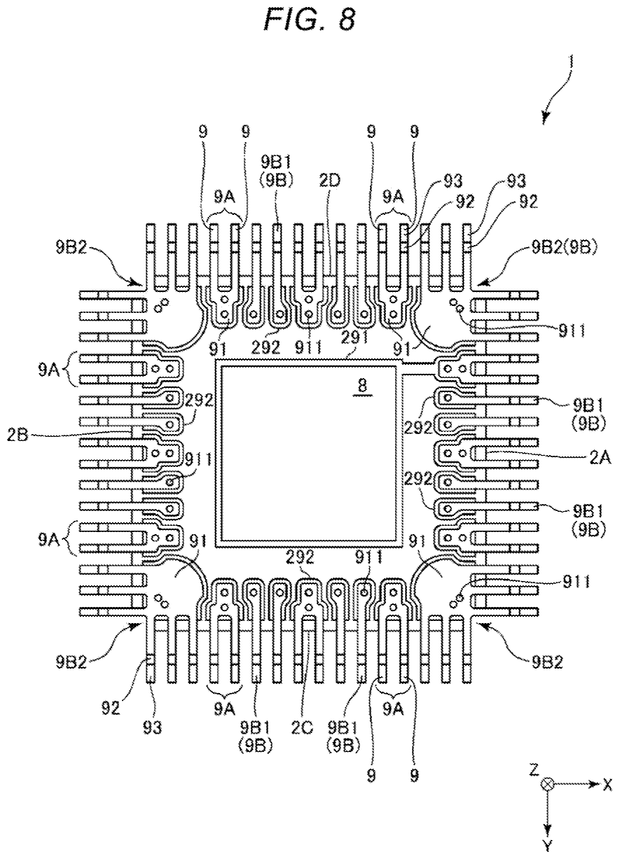

FIG. 1 is a lateral cross-sectional view showing an inertial measurement unit according to a preferred embodiment. FIG. 2 is a cross-sectional view taken along a line A-A in FIG. 1. FIG. 3 is a cross-sectional view of an angular velocity sensor. FIG. 4 is a cross-sectional view of an acceleration sensor. FIG. 5 is a side view of the inertial measurement unit. FIG. 6 is a cross-sectional view showing the relationship between the widths of a lead terminal and an external coupling terminal. FIG. 7 shows the relationship between the height of a substrate and a stress. FIG. 8 is a plan view showing lead terminals.

An inertial measurement unit 1 shown in FIG. 1 is an IMU (inertial measurement unit). As shown in FIGS. 1 and 2, the inertial measurement unit 1 has: a substrate 2; angular velocity sensors 3x, 3y, 3z and an acceleration sensor 5, which are inertial sensors installed at a top surface 21 of the substrate 2; a cap 7 bonded to the top surface 21 of the substrate 2 in the state of covering these inertial sensors; a semiconductor device 8 installed at a bottom surface 22 of the substrate 2; and a lead group 90 having a plurality of lead terminals 9 coupled to the bottom surface 22 of the substrate 2. Such an inertial measurement unit 1 is mounted at amounting target surface 100 via the lead terminals 9. The mounting target surface 100 is not particularly limited. However, a client substrate or the like used by a client of the inertial measurement unit 1 may be employed.

As shown in FIG. 2, the substrate 2 has a plate-like shape that is substantially square as viewed in a plan view and has the top surface 21 as a first surface and the bottom surface 22 as a second surface having a front-back relationship. Such a substrate 2 is a printed board. For example, a ceramic substrate, a glass epoxy substrate, a resin substrate or the like can be used as the substrate 2.

In this embodiment, the substrate 2 is a ceramic substrate such as a glass-ceramic substrate like a low-temperature co-fired ceramic substrate, or an alumina ceramic substrate. Since a ceramic substrate is used as the substrate 2, the substrate 2 is highly anti-corrosive. The substrate 2 also has high mechanical strength. Moreover, the substrate 2 is less likely to absorb moisture and also has excellent heat resistance and is therefore less likely to be damaged by heat applied when the inertial measurement unit 1 is manufactured. Also, as the substrate 2 is made of the same material as a base 32 of the angular velocity sensors 3x, 3y, 3z, a thermal stress due to the difference in the coefficient of linear expansion between these elements is less likely to occur. Thus, the inertial measurement unit has high long-term reliability.

For the sake of convenience of the description, only a ground wiring 291 arranged at the bottom surface 22 and an external coupling terminal 292 coupled to the lead terminal 9 are illustrated as wirings formed at the substrate 2.

As shown in FIG. 1, the three angular velocity sensors 3x, 3y, 3z are installed at the top surface 21 of the substrate 2. Of these, the angular velocity sensor 3x is a sensor detecting an angular velocity about the X-axis. The angular velocity sensor 3y is a sensor detecting an angular velocity about the Y-axis. The angular velocity sensor 3z is a sensor detecting an angular velocity about the Z-axis.

The basic configurations of the angular velocity sensors 3x, 3y, 3z are similar to each other. The angular velocity sensors 3x, 3y, 3z are mounted in different attitudes so that the detection axes thereof face the X-axis, the Y-axis, and the Z-axis, respectively. To take the angular velocity sensor 3x as a representative example, the angular velocity sensor 3x has a package 31, an angular velocity sensor element 34 accommodated in the package 31, and a temperature sensor 35 installed at the package 31, as shown in FIG. 3. The package 31 has a base 32 having a recess part 321 open to one main surface and a recess part 322 open to the other main surface, and a cap 33 bonded to the base 32 in such a way as to close the opening of the recess part 321. The angular velocity sensor element 34 is accommodated in the recess part 321. The temperature sensor 35 is arranged in the recess part 322. The base 32 is formed of a ceramic material such as alumina. The cap 33 is formed of a metal material such as Kovar. However, the materials of these elements are not particularly limited.

The angular velocity sensor element 34 is, for example, a quartz crystal vibrator element having a drive arm and a vibrating arm. In such a quartz crystal vibrator element, when an angular velocity about the detection axis is applied in the state where a drive signal is applied causing the drive arm to perform a drive vibration, a detection vibration is excited in a detection arm due to a Coriolis force. An electric charge generated in the detection arm by the detection vibration is extracted as a detection signal. Based on the extracted detection signal, the angular velocity can be found.

However, the configuration of the angular velocity sensor 3x is not particularly limited, provided that the angular velocity sensor 3x can detect an angular velocity along the X-axis direction. The same applies to the angular velocity sensors 3y and 3z.

As shown in FIG. 1, the acceleration sensor 5 is installed at the top surface 21 of the substrate 2, along with the angular velocity sensors 3x, 3y, 3z as described above. As shown in FIG. 4, the acceleration sensor 5 has a package 51, acceleration sensor elements 54, 55, 56 accommodated in the package 51, and a temperature sensor 57. The package 51 has a base 52 having a recess part 521 formed overlapping the acceleration sensor elements 54, 55, 56, and a cap 53 having a recess part 531 open toward the base 52 and bonded to the base 52 in such away as to accommodate the acceleration sensor elements 54, 55, 56 in the recess part 531. The base 52 and the cap 53 can be formed of silicon, various glass materials, or the like.

The acceleration sensor element 54 is an element detecting an acceleration in the X-axis direction. The acceleration sensor element 55 is an element detecting an acceleration in the Y-axis direction. The acceleration sensor element 56 is an element detecting an acceleration in the Z-axis direction. These acceleration sensor elements 54, 55, 56 are silicon vibrator elements having a fixed electrode fixed to the base 52 and a moving electrode that is displaceable in relation to the base 52. When an acceleration in the direction of the detection axis is applied, the moving electrode is displaced in relation to the fixed electrode, and an electrostatic capacitance formed between the fixed electrode and the moving electrode changes. The change in the electrostatic capacitance in the acceleration sensor elements 54, 55, 56 is extracted as a detection signal. Based on the extracted detection signal, the acceleration in each axial direction can be found.

The acceleration sensor 5 has been described. The configuration of the acceleration sensor 5 is not particularly limited, provided that the functions of the acceleration sensor 5 can be implemented. For example, the acceleration sensor elements 54, 55, 56 are not limited to silicon vibrator elements and may be, for example, quartz crystal vibrator elements and may be configured to detect an acceleration, based on an electric charge generated by a vibration.

In this embodiment, as described above, a configuration where four inertial sensors are installed at the top surface 21 of the substrate 2 is employed. However, the configuration of the inertial measurement unit 1 is not limited to this, provided that at least one inertial sensor is installed. The inertia that can be detected by the inertial sensor is not limited to acceleration and angular velocity.

As shown in FIGS. 1 and 2, the cap 7 is bonded to the top surface 21 of the substrate 2 and accommodates the angular velocity sensors 3x, 3y, 3z and the acceleration sensor 5, which are inertial sensors, between the substrate 2 and the cap 7. The cap 7 has a base part 71 having a recess part 711 open toward the top surface 21, and four tab parts 72 protruding inward from a bottom end part of the base part 71. The cap 7 is arranged at the top surface 21 of the substrate 2 in such a way as to accommodate the angular velocity sensors 3x, 3y, 3z and the acceleration sensor 5 in the recess part 711 and is bonded to the top surface 21 at the tab parts 72.

As the cap 7 accommodating the angular velocity sensors 3x, 3y, 3z and the acceleration sensor 5 is provided in this way, the angular velocity sensors 3x, 3y, 3z and the acceleration sensor 5 can be protected from an impact or the like. In this embodiment, the inside of the recess part 711 is not sealed and communicates with the outside. However, this is not limiting. The inside of the recess part 711 may be sealed, having a desired atmosphere.

The cap 7 is electrically conductive and is formed of, for example, a metal material. Particularly in this embodiment, the cap 7 is formed of alloy 42, which is an iron-nickel alloy. This can sufficiently reduce the difference in the coefficient of linear expansion between the substrate 2 formed of a ceramic substrate and the cap 7 and thus can effectively restrain the occurrence of a thermal stress due to the difference in the coefficient of linear expansion. Therefore, the inertial measurement unit 1 is less susceptible to the influence of ambient temperature and has stable characteristics.

The cap 7 is electrically coupled to the semiconductor device 8, for example, via the tab parts 72 and is coupled to the ground when the inertial measurement unit 1 is in use. This makes the cap 7 function as a shield against external electromagnetic noises and thus stabilizes the driving of each inertial sensor accommodated inside the cap 7. However, the material forming the cap 7 is not limited to a metal material. For example, various ceramic materials, various resin materials, a semiconductor material such as silicon, various glass materials and the like can be used.

Each part located on the side of the top surface 21 of the substrate 2 has been described. Now, each part located on the side of the bottom surface 22 of the substrate 2 will be described. As shown in FIG. 2, the semiconductor device 8 is installed at the bottom surface 22 of the substrate 2. More specifically, the semiconductor device 8 is installed on the ground wiring 291 formed at the bottom surface 22. Unlike the inertial sensors located on the side of the top surface 21, the semiconductor device 8 is not covered by a member such as the cap 7 and is exposed outside the inertial measurement unit 1. In other words, the semiconductor device 8 is exposed from between the plurality of lead terminals 9, as viewed in a plan view from a direction orthogonal to the Z-axis, as shown in FIG. 5. The semiconductor device 8 is a device that tends to generate heat. Therefore, as the semiconductor device 8 is arranged to be exposed outside the inertial measurement unit 1, the heat of the semiconductor device 8 can be efficiently dissipated outside the inertial measurement unit 1. This can effectively restrain a variation or abnormality in the inertial detection characteristic and a malfunction or the like of the inertial measurement unit 1 due to an excessive temperature rise in the inertial measurement unit 1 caused by the heat trapped inside the inertial measurement unit 1.

The semiconductor device 8 is electrically coupled to the angular velocity sensors 3x, 3y, 3z and the acceleration sensor 5 via the substrate 2. The semiconductor device 8 is a circuit element and is formed, for example, by molding a bare chip, which is a semiconductor chip. As described above, the semiconductor device 8 is exposed outside. Therefore, molding a bare chip to form the semiconductor device 8 enables the protection of the semiconductor device 8 from moisture, dust, impact and the like.

As shown in FIG. 2, the semiconductor device 8 has a processor 81 processing information such as a CPU or an MPU, a memory 82 communicatively coupled to the processor 81, and an interface 83 inputting and outputting data. In the memory 82, various programs executable by the processor 81 are saved. The processor 81 can read and execute various programs or the like stored in the memory 82. Via the interface 83, a drive signal is inputted and the result of detection by each inertial sensor is outputted.

The processor 81 has a drive circuit 811 separately controlling the driving of the angular velocity sensors 3x, 3y, 3z and the acceleration sensor 5, and a detection circuit 812 separately detecting an angular velocity and an acceleration along each axis, based on detection signals from the angular velocity sensors 3x, 3y, 3z and the acceleration sensor 5. The detection circuit 812 has a temperature compensation function for compensating the detection signals, based on a temperature detected by the temperature sensor 57 installed in the acceleration sensor 5. Thus, the angular velocity and the acceleration can be accurately detected without being influenced by ambient temperature.

However, this is not limiting. Instead of the temperature sensor 57, one of the temperature sensors 35 installed in the angular velocity sensors 3x, 3y, 3z may be used for temperature compensation. Also, the temperature sensor 35 installed in the angular velocity sensor 3x may be used for the temperature compensation of the detection signal from the angular velocity sensor 3x. The temperature sensor 35 installed in the angular velocity sensor 3y may be used for the temperature compensation of the detection signal from the angular velocity sensor 3y. The temperature sensor 35 installed in the angular velocity sensor 3z may be used for the temperature compensation of the detection signal from the angular velocity sensor 3z. The temperature sensor 57 installed in the acceleration sensor 5 may be used for the temperature compensation of the detection signal from the acceleration sensor 5. This enables more accurate detection of the temperature of each inertial sensor and more accurate temperature compensation.

The interface 83 transmits and receives a signal, accepts a command from an external device such as a host computer, and outputs a detected angular velocity and acceleration to the external device. The communication method of the interface 83 is not particularly limited. However, in this embodiment, SPI (Serial Peripheral Interface) communication is employed. SPI communication is a communication method suitable for coupling a plurality of sensors. Since all the signals about angular velocity and acceleration can be outputted from one lead terminal 9, the number of pins in the inertial measurement unit 1 can be reduced.

As shown in FIG. 1, the semiconductor device 8 overlaps the acceleration sensor 5, on which the temperature sensor 57 used for temperature compensation is mounted, as viewed in a plan view from the Z-axis direction. Thus, the temperature sensor 57 can be arranged near the semiconductor device 8, which is a heat source, and thus can accurately detect the internal temperature of the inertial measurement unit 1. Therefore, temperature compensation can be performed more accurately. Particularly in this embodiment, the semiconductor device 8 overlaps the temperature sensor 57, as viewed in a plan view from the Z-axis direction. Therefore, temperature compensation can be performed more accurately.

In the semiconductor device 8, the processor 81 tends to generate heat. In the processor 81, an area S where a logic circuit is formed particularly tends to generate heat. Therefore, in this embodiment, as shown in FIG. 1, the processor 81 overlaps the temperature sensor 57, as viewed in a plan view from the Z-axis direction. Also, the area S, where the logic circuit is formed, in the processor 81 overlaps the temperature sensor 57, as viewed in a plan view from the Z-axis direction. Thus, temperature compensation can be performed more accurately. Although the area S is shown as a rectangle for the sake of convenience of the description, the shape of the area S is not limited to a rectangle. The area S may be divided into a plurality of parts.

The semiconductor device 8 also has a regulator such as an LDO (low-dropout) regulator as an element that tends to generate heat, in addition to the processor 81. Therefore, the acceleration sensor 5, particularly the temperature sensor 57, may be arranged overlapping the regulator, as viewed in a plan view from the Z-axis direction.

It has been described that the angular velocity sensors 3x, 3y, 3z and the acceleration sensor 5 are installed at the top surface 21 of the substrate 2 and that the semiconductor device 8 is installed at the bottom surface 22. Also, other circuit elements such as a resistor and a capacitor may be installed at the top surface 21 and the bottom surface 22 of the substrate 2. These circuit elements may or may not form a part of the circuit formed in the semiconductor device 8.

The lead group 90 will now be described. As shown in FIG. 1, the lead group 90 has a first lead group 90A having a plurality of lead terminals 9 arranged along a first side 2A of the substrate 2, a second lead group 90B having a plurality of lead terminals 9 arranged along a second side 2B opposite the first side 2A of the substrate 2, a third lead group 90C having a plurality of lead terminals 9 arranged along a third side 2C of the substrate 2, and a fourth lead group 90D having a plurality of lead terminals 9 arranged along a fourth side 2D opposite the third side 2C of the substrate 2.

However, the configuration of the lead group 90 is not limited to this. For example, one, two, or three of the first to fourth lead groups 90A to 90D may be omitted. For example, the lead group 90 may be formed of the first lead group 90A and the second lead group 90B.

The plurality of lead terminals 9 included in the lead group 90 are formed, for example, by cutting a lead frame at the time of manufacture, and are formed of, for example, an iron-based material or a copper-based material. As shown in FIG. 2, each of such a plurality of lead terminals 9 has a first part 91 coupled to the substrate 2, a second part 92 mounted at the mounting target surface 100, and a third part 93 located between the first part 91 and the second part 92 and extending in a direction having a component in the Z-axis direction.

The first part 91 extends in a direction parallel to the substrate 2 and is mounted via a solder B1 at the external coupling terminal 292 formed at the bottom surface 22 of the substrate 2. As the first part 91 is thus mounted at the bottom surface 22 of the substrate 2, a gap G between the semiconductor device 8 and the mounting target surface 100 can be made wider than when the first part 91 is mounted at the top surface 21. Therefore, the heat dissipation effect of the semiconductor device 8 is improved. Moreover, since the first part 91 is mounted at the bottom surface 22 of the substrate 2, the interference between the lead terminal 9 and the cap 7 can be prevented. The first part 91 may be mounted at the external coupling terminal 292, using other materials than the solder B1, such as a brazing material, a metal bump, or an electrically conductive adhesive.

As shown in FIG. 2, a penetration hole 911 is formed in the first part 91. As the penetration hole 911 is thus formed in the first part 91, the volume of the solder B1 mounted to bond together the lead terminal 9 and the external coupling terminal 292 can be increased. Also, the contact area between the solder B1 and the first part 91 can be increased. This increases the reliability of the mounting of the lead terminal 9 at the external coupling terminal 292. The number of penetration holes 911 formed in the first part 91 is not particularly limited. The penetration hole 911 may be omitted from the first part 91.

Each corner part of the first part 91 is rounded. Thus, stress concentration is less likely to occur in the corner parts of the first part 91. This makes the solder B1 less likely to crack and increases the reliability of the mounting of the lead terminal 9 at the external coupling terminal 292.

As shown in FIG. 6, a width W1 of the first part 91 is smaller than a width W of the external coupling terminal 292. That is, W1<W. In FIG. 6, for the sake of convenience of the description, a lead terminal 9 included in the fourth lead group 90D is illustrated and the width W is a length in a direction parallel to the width W1. The first part 91 is included inside the external coupling terminal 292, as viewed in a plan view from the Z-axis direction. In such a configuration, the solder bonding these elements together is in a fillet shape and this increases the reliability of the mounting of the lead terminal 9 at the external coupling terminal 292. However, the relationship between the widths W1, W is not limited to this example. In this embodiment, the fillet-shaped solder is located more to the inside than the outline of the substrate 2, as viewed in a plan view from the Z-axis direction. This enables the lead group 90 to be formed in a minimum size and thus enables miniaturization of the inertial measurement unit 1.

As shown in FIG. 2, the second part 92 is mounted at the mounting target surface 100 via a solder B2. The second part 92 is located further away from the substrate 2 than the semiconductor device 8 in the Z-axis direction. That is, a separation distance D1 in the Z-axis direction between the second part 92 and the substrate 2 is longer than a separation distance D2 in the Z-axis direction between the bottom surface of the semiconductor device 8 and the substrate 2. Therefore, in the state where the inertial measurement unit 1 is mounted at the mounting target surface 100 via the lead terminals 9, that is, in the state where the lead terminals 9 are supported by the mounting target surface 100, the semiconductor device 8 and the mounting target surface 100 are spaced apart from each other and the gap G is formed between these elements. Thus, the heat of the semiconductor device 8 can be efficiently dissipated outside. Also, for example, the propagation of heat from the mounting target surface 100 to the semiconductor device 8 is restrained and therefore an unintended excessive temperature rise in the semiconductor device 8 can be restrained. This stabilizes the driving of the inertial measurement unit 1.

The third part 93 extends in a direction tilting from the Z-axis in such a way as to form an acute angle with the mounting target surface 100. However, this configuration is not limiting. For example, the third part 93 may extend in the Z-axis direction. For example, when a stress is generated due to the difference in the coefficient of linear expansion between the substrate 2 and the client substrate having the mounting target surface 100, the third part 93 of the lead terminal 9 is deformed, thus relaxing the stress applied to the substrate 2. This can effectively restrain deterioration in the sensor characteristics and deterioration in the reliability of mounting due to the difference in the coefficient of linear expansion.

A height H of such a lead terminal 9 is not particularly limited but may preferably be 1.7 mm or more. FIG. 7 shows the result of a simulation showing the relationship between the height H of the lead terminal 9 and a stress when a thermal load is applied, and shows the height dependence of the stress at the mounted part. As shown in FIG. 7, the stress applied to the mounted part becomes lower as the height H of the lead terminal 9 becomes higher. Therefore, in order to relax the stress, it is desirable to make the height H of the lead terminal 9 as high as possible. The reduction in the stress due to increasing the height H is saturated where H=1.7 mm or more. Therefore, setting the height H of the lead terminal 9 to 1.7 mm or more enables the setting of the stress to a saturation value. This can sufficiently reduce the stress applied to the mounted part of the solder B1 and thus can effectively restrain the cracking of the solder B1 caused by the stress due to the difference in the coefficient of linear expansion. If the height H is too high, it obstructs the miniaturization of the inertial measurement unit 1. Therefore, preferably, the height H is set to be smaller than at least the total length of the lead terminal 9. This can achieve the miniaturization of the inertial measurement unit 1 and can also achieve improvement in the reliability of mounting.

As shown in FIG. 8, the plurality of lead terminals 9 include a plurality of signal lead terminals 9A electrically coupled to the semiconductor device 8 and functioning as signal terminals, and a plurality of NC lead terminals 9B not functioning as signal terminals and being coupled to the ground when the inertial measurement unit 1 is in use. Between two neighboring signal lead terminals 9A, at least one NC lead terminal 9B is arranged. Since an NC lead terminal 9B coupled to the ground is thus arranged between two neighboring signal lead terminals 9A, the capacitive coupling between the two neighboring signal lead terminals 9A is restrained and therefore the signal lead terminals 9A are less likely to be affected by a noise.

Each of the plurality of signal lead terminals 9A is formed of two neighboring lead terminals 9 combined together at the first part 91 and is in the shape of a tuning fork. As the signal lead terminal 9A is thus formed of two lead terminals 9, even when one lead terminal 9 is broken or has contact failure, the transmission and reception of signals can be performed via the other lead terminal 9. Therefore, the transmission and reception of signals can be performed more securely.

As shown in FIG. 8, at least one signal lead terminal 9A is electrically coupled to the ground wiring 291. Thus, the heat of the semiconductor device 8 can be dissipated outside via the ground wiring 291, the external coupling terminal 292, the solder B1, and the signal lead terminal 9A. Therefore, the heat of the semiconductor device 8 can be efficiently dissipated.

The plurality of NC lead terminals 9B include a plurality of first NC lead terminals 9B1 arranged along the first to four sides 2A to 2D, and four second NC lead terminals 9B2 located in the respective corner parts of the substrate 2.

Each of the plurality of first NC lead terminals 9B1 is formed of one lead terminal 9. Between two neighboring signal lead terminals 9A, two first NC lead terminals 9B1 are arranged. Thus, the capacitive coupling between the two neighboring signal lead terminals 9A is effectively restrained and therefore the signal lead terminals 9A are less likely to be affected by a noise. However, the number of first NC lead terminals 9B1 arranged between two neighboring signal lead terminals 9A is not particularly limited.

Each of the four second NC lead terminals 9B2 is formed of six neighboring lead terminal 9 combined together at the first part 91. In other words, each of the plurality of second NC lead terminals 9B2 is formed of one first part 91 and six second and third parts 92, 93 branching off from the first part 91. Specifically, in the corner part where the first side 2A and the third side 2C intersect each other, three lead terminals 9 located near the third side 2C, of the plurality of lead terminals 9 arranged along the first side 2A, and three lead terminals 9 located near the first side 2A, of the plurality of lead terminals 9 arranged along the third side 2C, are combined together at the first part 91 and thus form one second NC lead terminal 9B2. The second NC lead terminal 9B2 is formed similarly in the corner part where the first side 2A and the fourth side 2D intersect each other, the corner part where the second side 2B and the third side 2C intersect each other, and the corner part where the second side 2B and the fourth side 2D intersect each other.

In the state where the inertial measurement unit 1 is mounted at the mounting target surface 100 via the lead terminals 9, that is, in the state where the lead terminals 9 are supported by the mounting target surface 100, a higher stress tends to be applied to the corner parts of the substrate 2 and therefore the solder B1 located at these parts tends to crack. Combining six lead terminals 9 located in the corner part to form one second NC lead terminal 9B2 can increase the contact area between the solder B1 and the first part 91 and thus increases the reliability of the mounting of the lead terminal 9 at the external coupling terminal 292. Also, the mechanical strength of the lead terminal 9 can be increased and damage to the lead terminal 9 due to the stress can be restrained.

The inertial measurement unit 1 has been described above. As described above, such the inertial measurement unit 1 has: where the X-axis, the Y-axis, and the Z-axis are provided as three axes orthogonal to each other, the substrate 2 including the top surface 21 as the first surface and the bottom surface 22 as the second surface orthogonal to the Z-axis and having a front-back relationship with each other; the angular velocity sensors 3x, 3y, 3z and the acceleration sensor 5, which are inertial sensors installed at the top surface 21 of the substrate 2; the semiconductor device 8 installed at the bottom surface 22 of the substrate 2 and electrically coupled to the angular velocity sensors 3x, 3y, 3z and the acceleration sensor 5; and the plurality of lead terminals 9 coupled to the substrate 2 and configured to support the substrate 2 to the mounting target surface 100. The plurality of lead terminals 9 have the first part 91 coupled to the substrate 2, the second part 92 mounted at the mounting target surface 100, and the third part 93 located between the first part 91 and the second part 92 and extending in a direction having a component along the Z-axis. The semiconductor device 8 is exposed from between the plurality of lead terminals 9, as viewed in a plan view from a direction orthogonal to the Z-axis. The semiconductor device 8 is a device that tends to generate heat. Therefore, as the semiconductor device 8 is arranged to be exposed outside the inertial measurement unit 1, the heat of the semiconductor device 8 can be efficiently dissipated outside the inertial measurement unit 1. This can effectively restrain a variation or abnormality in the inertial detection characteristic and a malfunction or the like of the inertial measurement unit 1 due to an excessive temperature rise in the inertial measurement unit 1 caused by the heat trapped inside the inertial measurement unit 1.

As described above, in a direction along the Z-axis, the second part 92 is located further away from the substrate 2 than the semiconductor device 8. Therefore, in the state where the lead terminals 9 are supported by the mounting target surface 100, the semiconductor device 8 can be spaced apart from the mounting target surface 100. Thus, the heat of the semiconductor device 8 can be efficiently dissipated outside. Also, for example, the propagation of heat from the mounting target surface 100 to the semiconductor device 8 is restrained and therefore an unintended excessive temperature rise in the semiconductor device 8 can be restrained. This stabilizes the driving of the inertial measurement unit 1.

As described above, the first part 91 is coupled to the bottom surface 22 of the substrate 2. Therefore, the gap between the semiconductor device 8 and the mounting target surface 100 can be made wider than when the first part 91 is mounted at the top surface 21. This enables more efficient dissipation of heat from the semiconductor device 8.

As described above, at least one lead terminal 9, that is, in the signal lead terminal 9A in the embodiment, is configured in such a way that a plurality of parts having the third part 93 and the second part 92 branch off from the first part 91. Thus, even when one of the parts is broken or has contact failure, the transmission and reception of signals can be performed via the other part. Therefore, the transmission and reception of signals can be performed more securely.

As described above, the semiconductor device 8 has the processor 81 processing information, the memory 82 communicatively coupled to the processor 81, and the interface 83 inputting and outputting data. In such a semiconductor device 8, particularly the processor 81 is a heat source. Since the semiconductor device 8 tends to generate heat, the effects of the inertial measurement unit 1 can be achieved more significantly.

As described above, the inertial measurement unit 1 has the temperature sensor 57. The temperature sensor 57 overlaps the processor 81, as viewed in a plan view from a direction along the Z-axis. Therefore, the temperature sensor 57 can accurately detect the temperature of the inertial measurement unit 1. Thus, temperature compensation of a detection signal from the inertial sensor can be performed accurately via the temperature sensor 57.

The inertial measurement unit according to the present disclosure has been described, based on the illustrated embodiment. However, the present disclosure is not limited to this embodiment. The configuration of each part can be replaced with any configuration having a similar function. Also, any other component may be added to the inertial measurement unit according to the present disclosure.

What is claimed is:

1. An inertial measurement unit comprising:
where an X-axis, a Y-axis, and a Z-axis are provided as three axes orthogonal to each other,
a substrate including a first surface and a second surface orthogonal to the Z-axis and having a front-back relationship with each other;
an inertial sensor installed at the first surface of the substrate;
a semiconductor device installed at the second surface of the substrate and electrically coupled to the inertial sensor; and
a plurality of lead terminals coupled to the substrate and configured to support the substrate to a mounting target surface, wherein
the plurality of lead terminals have a first part coupled to the substrate, a second part mounted at the mounting target surface, and a third part located between the first part and the second part and extending in a direction having a component along the Z-axis, and
the semiconductor device is exposed from between the plurality of lead terminals, as viewed in a plan view from a direction orthogonal to the Z-axis.

2. The inertial measurement unit according to claim 1, wherein
in a direction along the Z-axis, the second part is located further away from the substrate than the semiconductor device.

3. The inertial measurement unit according to claim 2, wherein
in a state where the plurality of lead terminals are supported by the mounting target surface,
the semiconductor device is spaced apart from the mounting target surface.

4. The inertial measurement unit according to claim 1, wherein
the first part is coupled to the second surface of the substrate.

5. The inertial measurement unit according to claim 1, wherein
at least one of the lead terminals is configured in such a way that a plurality of parts having the third part and the second part branch off from the first part.

6. The inertial measurement unit according to claim 1, wherein
the semiconductor device has a processor processing information, a memory communicatively coupled to the processor, and an interface inputting and outputting data.

7. The inertial measurement unit according to claim 6, further comprising
a temperature sensor, wherein
the temperature sensor overlaps the processor, as viewed in a plan view from a direction along the Z-axis.
